(19) United States
(12) Patent Application Publication
(10) Pub. No.: US 2011/0281564 A1
(43) Pub. Date: Nov. 17, 2011

(54) VEHICLE DRIVER BEHAVIOR MONITORING AND CORRELATION

(76) Inventors: David L. Armitage, Golden, CO (US); Gregory Froim Kushnir, Denver, CO (US); Mark Alvin Mason, Thornton, CO (US)

(21) Appl. No.: 13/105,368

(22) Filed: May 11, 2011

Related U.S. Application Data
(60) Provisional application No. 61/333,448, filed on May 11, 2010.
(60) Provisional application No. 61/333,457, filed on May 11, 2010.

(51) Int. Cl. H04W 24/00

(52) U.S. Cl. 455/414.1

(57) ABSTRACT

What is disclosed are various methods of operating vehicle monitoring systems. One example method includes receiving activity information for a transportation vehicle, receiving mobile phone usage information associated with the transportation vehicle, and processing the activity information and the mobile phone usage information to determine behavior of a driver operating the transportation vehicle. The method could also include, in some examples, processing the activity information and the mobile phone usage information to identify the driver operating the transportation vehicle. Other example methods include processing motion data of a vehicle associated with the vehicle monitoring system to determine a route of the vehicle, processing the route to subdivide the route into a plurality of segments based upon the motion data, and determining if the vehicle was exceeding speed limits associated with any of the plurality of segments and reporting speeding information to a driver of the vehicle.

### RELATED APPLICATIONS

This patent application is related to and claims priority to U.S. Provisional Patent Application No. 61/333,448, entitled “Correlation of Driver Behavior to Vehicle Activity,” filed on May 11, 2010, and U.S. Provisional Patent Application No. 61/333,457, entitled “Segment Based Driving Analysis and Reporting,” filed on May 11, 2010, which are hereby incorporated by reference in their entirety.

### TECHNICAL FIELD

Aspects of the disclosure are related to the field of vehicle monitoring systems, and in particular, vehicle monitoring systems to monitor and analyze driver and vehicle behavior.

### TECHNICAL BACKGROUND

Performance monitoring tools are used to assess the operation of a vehicle, such as an automobile, airplane, or the like. These tools analyze the performance of the vehicle and the various internal systems which make up the vehicle. Assessments on performance may be achieved in both real time and non-real time manners.

Cars and trucks may contain On Board Diagnostics (OBD) systems which provide some level of self-diagnostic and information reporting capability. OBD systems were originally developed to be used during the manufacturing and test processes. However, the capabilities of these systems and their uses have expanded dramatically since that time. Currently, OBD systems give repair technicians, vehicle owners, and emissions testing agencies electronic access to state of health and operational information pertaining to many different vehicle subsystems. Historically, many vehicle functions like braking, speed indication, and fuel delivery were performed by mechanical systems and components. Presently, many of these vehicle functions are controlled or monitored through electronic means, thereby making electronic information about the performance and operations of those systems readily available. It is now possible to electronically monitor tens, if not hundreds, of operational characteristics of a vehicle using OBD systems.

While OBD is a generic term referring to any of a class of systems which provide these reporting capabilities, there are industry standard implementations which provide for standardized connectors, pinouts, and signal characteristics, among other things. Currently, the most prevalent system is the OBDII system. OBDII provides access to a wide range of data from the engine control unit (ECU) as well as other vehicle systems. The system offers standardized methods for requesting various diagnostic data as well as a list of standard parameters which may be available from an OBDII system.

Driver behavior and the potential for vehicle accidents has been a longstanding concern. In recent years, driver behavior has garnered additional attention in various media outlets. In particular, some media have reported on the impact of new communication technologies, such as cell phones and text messaging, on driver behavior. It has been shown that engaging with these technologies while operating a vehicle can have significant adverse effects. Consequently, business owners and government agencies that have drivers operating vehicles on their behalf have heightened concerns about the driving behaviors of their drivers and the ensuing risks which may be associated with those behaviors. Parents may be concerned about the driving behaviors of their children and wish to affect those driving behaviors for similar reasons.

In addition to affecting the risks of an accident, driver behavior may have other important cost and environmental impacts as well. For example, rapid or frequent acceleration of a vehicle may result in less efficient fuel consumption or higher concentrations of pollutants. In addition, hard braking or excessive speed may result in increased maintenance costs, unexpected repair costs, or require premature vehicle replacement.

### OVERVIEW

What is disclosed is a method of operating a vehicle monitoring system. The method includes receiving activity information for a transportation vehicle, receiving mobile phone usage information associated with the transportation vehicle, and processing the activity information and the mobile phone usage information to determine behavior of a driver operating the transportation vehicle. The method could also include, in some examples, processing the activity information and the mobile phone usage information to identify the driver operating the transportation vehicle.

What is also disclosed is a method of operating a vehicle monitoring system. The method includes processing motion data of a vehicle associated with the vehicle monitoring system to determine a route of the vehicle, and processing the route to subdivide the route into a plurality of segments based upon the motion data. The method also includes receiving an estimated transit time for each of the plurality of segments, determining an actual transit time for each of the plurality of segments based upon the motion data, and processing the estimated transit time and the actual transit time for each of the plurality of segments to determine time thresholds associated with each of the plurality of segments. The method also includes processing the time thresholds to determine if the vehicle was exceeding speed limits associated with any of the plurality of segments and reporting speeding information to a driver of the vehicle.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a vehicle monitoring system.

FIG. 2 is a flow diagram illustrating a method of operating a vehicle monitoring system.

FIG. 3 is a system diagram illustrating a vehicle monitoring system.

FIG. 4 is a flow diagram illustrating a method of operating a vehicle monitoring system.

FIG. 5 is a block diagram illustrating a collection node.

FIG. 6 is a block diagram illustrating a wireless communication device.

FIG. 7 is a block diagram illustrating a vehicle monitor.

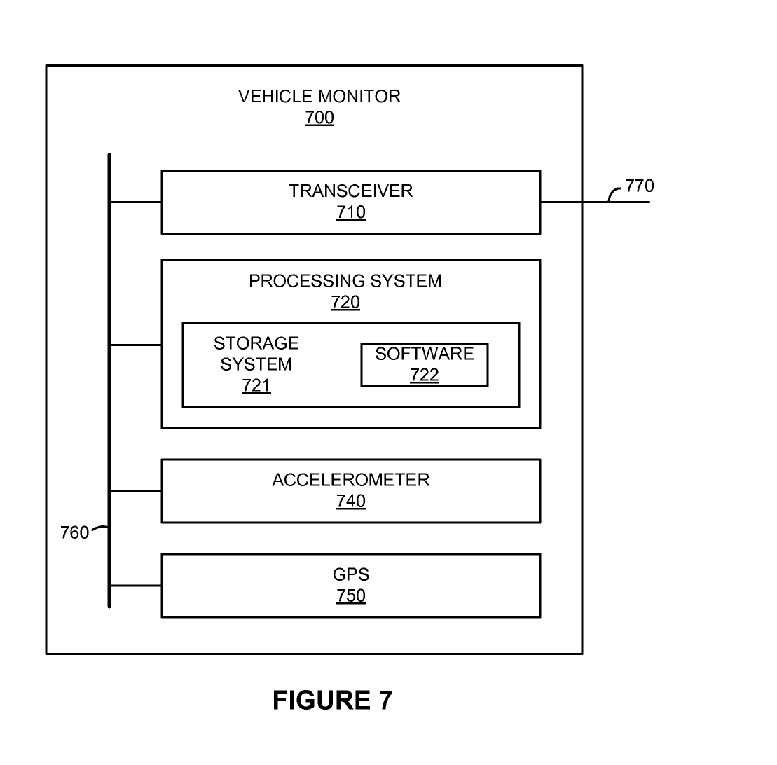

### DETAILED DESCRIPTION

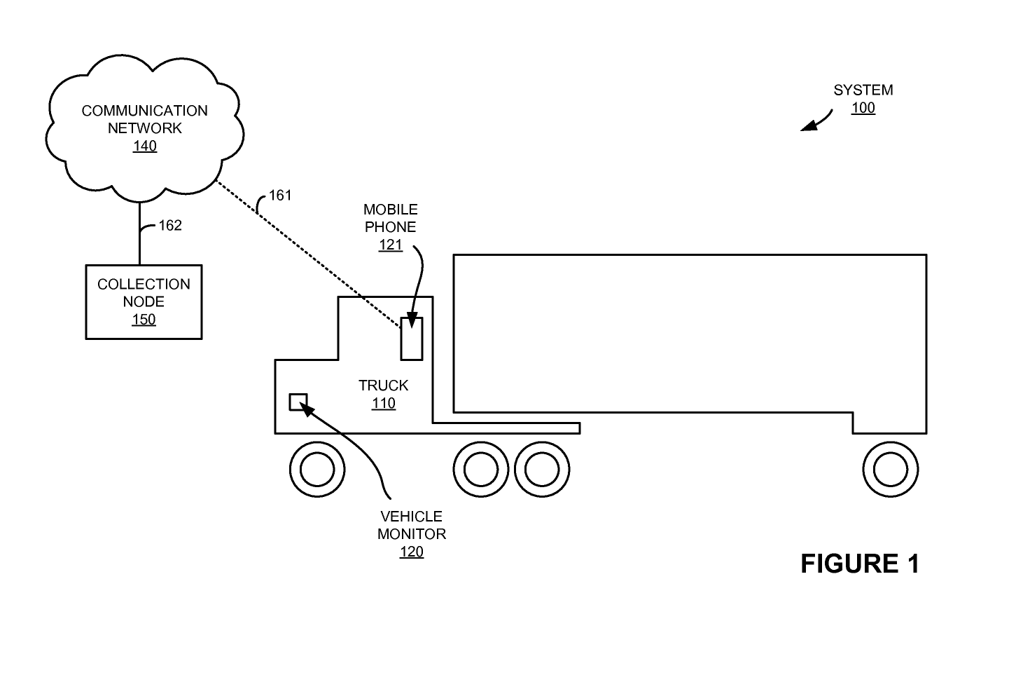

FIG. 1 is a system diagram illustrating vehicle monitoring system 100. System 100 includes truck 110, vehicle monitor 120, mobile phone 121, communication network 140, and collection node 150. Mobile phone 121 and communication network 140 communicate over wireless link 161. Communication network 140 and collection node 150 communicate over link 162.

Truck 110 is shown as a semi-trailer and tractor in this example. However, in other examples, truck 110 could instead be a different transportation vehicle, such as a passenger car, passenger truck, flatbed truck, construction vehicle, railway car, or other vehicle. Truck 110 includes vehicle monitor 120 and mobile phone 121.

Vehicle monitor 120 is coupled to the engine of truck 110. In this example, vehicle monitor 120 is coupled electrically to truck 110 through a vehicle interface (not shown) to monitor engine performance and receive information from the various systems associated with truck 110. The vehicle interface could include an OBD vehicle interface. Vehicle monitor 120 could also include a sensor portion, comprising thermometers, thermocouples, thermopiles, emitters/detectors, microphones, accelerometers, strain gauges, flow gauges, chemical sensors, micro-electromechanical system (MEMS) sensors, electrical sensors, among other sensing equipment and circuitry. Vehicle monitor 120 could also include a transceiver portion for communication with collection node 150. In some examples, the transceiver portion includes a wireline transceiver for communicating over a wire, optical fiber, or other medium. In other examples, the transceiver portion includes a wireless transceiver and antenna. Vehicle monitor 120 could also include a processing portion for receiving sensor and vehicle information, amplifying, scaling, modifying, adjusting, digitizing, or converting the information, as well as for controlling the transceiver portion and sensor portions. Vehicle monitor 120 could also comprise a power system, such as a battery or solar cell. Vehicle monitor 120 could also comprise a global positioning system (GPS) receiver, to receive and interpret signals from positioning satellites to determine geographic coordinates.

In operation, vehicle monitor 120 senses and monitors equipment associated with truck 110. The information monitored could include engine component temperature, ambient temperature, vibration, noise, acceleration, position, fuel usage, oxygen usage, emissions, braking, direction, steering, incline, engine start/stop status, transmission status, tire pressure, among other information. Vehicle monitor 120 is also configured to collect, store, and transfer the monitored information about truck 110. In some examples, vehicle monitor 120 is configured to wirelessly transmit the collected information to collection node 150, such as over a wireless communication network or satellite communication network while truck 110 is in motion. In other examples, vehicle monitor 120 is coupled via a wireless or wireline interface to collection node 150 while truck 110 is not in motion to transfer information collected and stored over a period of time, such as after a roundtrip delivery. Vehicle monitor 120 could also collect, store, and report other information, such as position, time, battery life, sensor status, inoperative sensors, serial numbers, equipment identifiers, among other information.

Mobile phone 121 is a mobile wireless telephone in this example. Mobile phone 121 comprises radio frequency (RF) communication circuitry and antenna elements. The RF communication circuitry typically includes amplifiers, filters, modulators, and signal processing circuitry. In many examples, mobile phone 121 includes circuitry and equipment to exchange communications of wireless communication services over wireless links, as provided by base stations associated with communication network 140. Mobile phone 121 may also include user interface systems, memory devices, non-transient computer-readable storage mediums, software, processing circuitry, cameras, sensor systems, accelerometers, compasses, GPS receivers, or other communication and circuitry components. Mobile phone 121 may also be another wireless communication device, such as subscriber equipment, customer equipment, access terminal, computer, e-book, mobile Internet appliance, wireless network interface card, media player, game console, or some other wireless communication apparatus, including combinations thereof. Although one mobile phone is shown in FIG. 1, it should be understood that a different number of mobile phones could be shown.

Mobile phone 121 could include complementary or additional sensors, equipment, and circuitry as to vehicle monitor 120 or collection node 150. In some examples, vehicle monitor 120 or collection node 150 are not employed, and only mobile phone 121 is employed. Specialized software or circuitry could be employed in mobile phone 121 to operate as described herein for vehicle monitor 121 or collection node 150.

Communication network 140 could include base stations, base station control systems, Internet access nodes, telephony service nodes, wireless data access points, routers, gateways, satellite systems, or other wireless communication systems, including combinations thereof. Communication network 140 may also comprise optical networks, asynchronous transfer mode (ATM) networks, packet networks, metropolitan-area networks (MAN), or other network topologies, equipment, or systems, including combinations thereof. In typical examples, communication network 140 includes many base stations and associated equipment for providing communication services to many wireless and mobile devices across a geographic region. In the example shown in FIG. 1, communication network 140 provides wireless communication service to mobile phone 140, such as cellular service, over a geographic area. Systems in communication network 140 also track and store usage information for mobile phone 121, such as call records, usage history, text message records, data usage, among other usage information.

Collection node 150 comprises equipment for receiving information about truck 110 and mobile phone 121. In some examples, the information is received from communication network 140 over link 162, while in other examples, the information is received over other communication pathways. Collection node 150 also includes communication interfaces, as well as a computer system, microprocessor, circuitry, or some other processing device or software system, and may be distributed among multiple processing devices. Examples of collection node 150 may also include software such as an operating system, logs, utilities, drivers, networking software, and other software stored on a non-transient computer-readable medium. Collection node 150 could also include application servers, application service provider systems, database systems, logistics systems, web servers, or other systems. Collection node 150 could collect vehicle and mobile phone information from many vehicles and mobile phones.

Wireless link 161 uses the air or space as the transport media. Wireless link 161 may use various protocols, such as Code Division Multiple Access (CDMA), Evolution-Data Optimized (EV-DO), single-carrier radio transmission technology link (1xRTT), Worldwide Interoperability for Microwave Access (WIMAX), Global System for Mobile Communication (GSM), Universal Mobile Telecommunications System (UMTS), Long Term Evolution (LTE), Wireless Fidelity (WiFi), High Speed Packet Access (HSPA), Radio Link Protocol (RLP), satellite phone communications, or some other wireless communication format, including combinations, improvements, or variations thereof.

Communication link 162 uses various communication media, such as air, space, metal, optical fiber, or some other signal propagation path, including combinations thereof. Communication link 162 could use various communication protocols, such as Internet Protocol (IP), Ethernet, Wireless Fidelity (WiFi), Bluetooth, Controller Area Network (CAN) bus, Inter-Integrated Circuit (I2C), 1-Wire, Radio Frequency Identification (RFID), Time Division Multiplex (TDM), asynchronous transfer mode (ATM), optical, synchronous optical networking (SONET), circuit-switched, communication signaling, or some other communication format, including combinations, improvements, or variations thereof. Communication link 162 could be a direct link or may include intermediate networks, systems, or devices. In some examples, communication link 162 operates using wireless protocols as described for wireless link 161.

Links 161-162 may each include many different signals sharing the same link—as represented by the associated lines in FIG. 1—comprising access channels, forward links, reverse links, user communications, communication sessions, overhead communications, frequencies, other channels, carriers, timeslots, spreading codes, transportation ports, logical transportation links, network sockets, packets, or communication directions.

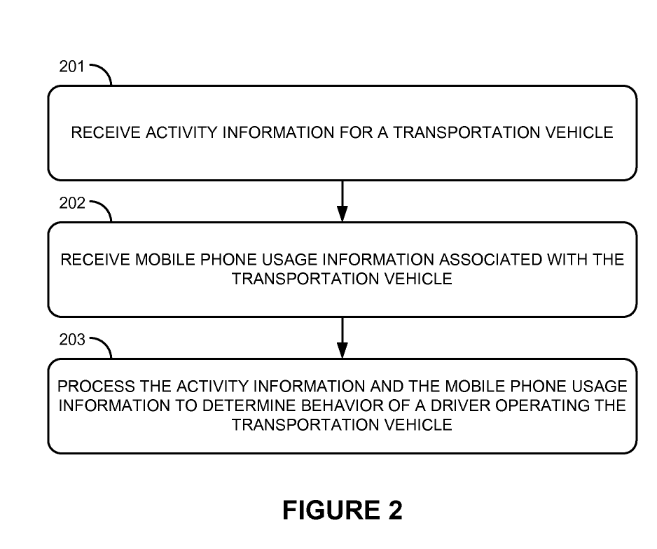

FIG. 2 is a flow diagram illustrating a method of operating vehicle monitoring system 100. The operations in FIG. 2 are referenced herein parenthetically. In FIG. 2, collection node 150 receives (201) activity information for a transportation vehicle. In this example, the transportation vehicle is truck 110. The information about the activities of truck 110 could be determined by vehicle monitor 120 or by mobile phone 121. The vehicle information could include engine component temperature, ambient temperature, vibration, noise, acceleration, position, fuel usage, oxygen usage, emissions, braking, direction, steering, incline, engine start/stop status, transmission status, tire pressure, position, time, battery life, sensor status, inoperative sensors, serial numbers, or other identifiers, among other information.

Collection node 150 receives (202) mobile phone usage information associated with the transportation vehicle. The usage information of mobile phone 121 could include voice call records, usage history, text message records, Internet usage, or data usage, among other usage information. In this example, communication network 140 tracks the usage information for mobile phone 121 and provides the usage information to collection node 150 over link 162.

Collection node 150 processes (203) the activity information and the mobile phone usage information to determine behavior of a driver operating the transportation vehicle. Collection node 150 can process the activity information received about truck 110 and the usage information for phone 121 to determine the reasonableness of driving behavior during driving incidents. For example, the activity information received about truck 110 and the usage information for phone 121 could be processed to determine if the driver of vehicle 110 was engaged in a phone call or text message on mobile phone 121 during the occurrence of a driving incident. A driving incident or driving event could include a hard braking event, an accident, a sudden directional change, a flat tire, among other events. The driving event could be determined by processing the vehicle information received about truck 110, such as by processing an acceleration/deceleration, a tire pressure event, engine start/stop events, or a timestamp, among other information. These driving events could then be correlated to activity of mobile phone 121.

As discussed above, activity records of mobile phone 121 could be obtained by collection node 150. These activity records could be provided to collection node 150 by a communication service provider of mobile phone 121, such as phone records from a phone company, cellular provider, information service provider, information collection agency, among others providers. In some examples, a call database or call history record is obtained from communication network 140 for activity of mobile phone 121. These activity records of mobile phone 121 could also include a timestamp and date to indicate when each activity occurred.

In some examples, more than one mobile phone or wireless communication device is located within truck 110, such as if a passenger was present with a mobile phone. In examples with more than one mobile phone, collection node 150 may have difficulty determining which person in truck 110 was engaging in activity on a mobile phone during a driving event. Collection node 150 could then process additional information to determine if the driver of truck 110 was using mobile phone 121 during a driving event. Multiple pieces of information could be collected and compared to determine a score, and the score could indicate the most likely driver of truck 110 based upon many factors.

In some examples, activity of a wireless headset interface of truck 110 could be processed to identify the driver of truck 110, such as when a wireless headset, such as a Bluetooth headset, is in use or when a headset has been synchronized to a mobile phone associated with a particular driver. For example, the driver may have registered the wireless headset interface of truck 110 with mobile phone 121, and when the wireless headset interface is in use, collection node 150 could determine that the driver, not a passenger, was engaged in activity with mobile phone 121.

In other examples, past driving patterns or driving history of the driver could be analyzed by collection node 150 to identify a driver of driving truck 110. Driving habits could be determined by collecting and storing past activity information of truck 110, or other trucks, for a set of multiple drivers, and processing the past activity information to create driver profiles. For example, a driver may accelerate or brake in a particular pattern or within a range of magnitudes, and the habits of different drivers can thus be differentiated.

In yet further examples, biometric sensors could be used to differentiate drivers of truck 110, such as facial recognition, fingerprint sensors, weight or weight distribution on a seat, among other biometrics. In other examples, a driver must sign in, log in, or otherwise identify him or herself as the current driver of truck 110, such as entering credentials via a smartcard or login/password combination.

In even further examples, when vehicle monitor 120 and mobile phone 121 each include acceleration sensors, the acceleration data could be compared between vehicle monitor 120 and mobile phone 121, or among multiple mobile phones within truck 110. During acceleration events, such as turns, cornering, bumps, or other events, differences in acceleration among the various devices can indicate a position within truck 110. The driver could then be identified based upon the position of the device. For example, during a cornering event, vehicle monitor 120 and mobile phone 121 may each experience different accelerations or force differences, even if for a brief portion of the cornering event. Additionally, a difference in the phase of acceleration, such as differing delays experienced by different mobile phones or vehicle monitor could differentiate positioning within truck 110. Information such as the center of mass of truck 110, a characterized behavior of truck 110 during cornering events, the masses of truck 110, vehicle monitor 120, or mobile phone 121, a predetermined position of vehicle monitor 120, or other factors, could be processed along with the accelerations experienced by vehicle monitor 120 and mobile phone 121 to determine a likely position of mobile phone 121 relative to vehicle monitor 120 or other mobile phones in truck 110. In examples where vehicle monitor 120 and mobile phone 121 each include a GPS receiver, a position of mobile phone 121 could be determined relative to a known or predetermined location of vehicle monitor 120 in truck 110. The correlation of mobile phone 121 to a driver of truck 110 could then be determined based upon the physical location of mobile phone 121 within truck 110. For example, if mobile phone 121 is located near to the driver's seat or body during use of mobile phone 121, then collection node 150 could determine that the driver is associated with mobile phone 121 at that time.

Additionally, collection node 150 could process the information received about truck 110 and the usage information for phone 121 to determine a driver of truck 110 to associate different drivers with trips or routes from a trip log. Trip reports or logs as created by drivers or logging systems could be compared to a driver identified as described above. The trip reports could be audited to ensure that the driver indicated on the trip report correlates to the driver identified as the driver of truck 110. For example, if the driver of truck 110 is correlated to mobile phone 121 as described above, the trip report can be audited to determine if the proper driver was associated with the trip. Also, as discussed above, past driving patterns or driving history of drivers could be analyzed by collection node 150 to identify a driver of driving truck 110. Driving habits could be determined by collecting past activity information on truck 110 or other trucks for a set of multiple drivers, and processing the past activity information to create driver profiles. For example, some drivers accelerate or brake in a particular pattern or within a range of magnitudes, have similar start and stop locations (i.e. certain fuel stations or eating locations and times), or have other habits, and different drivers can thus be differentiated. In other examples, the driving data could be processed to determine if a driver decelerates, such as pulling over to the side of a roadway, when engaged in activity with mobile phone 121, such as when an incoming call is received.

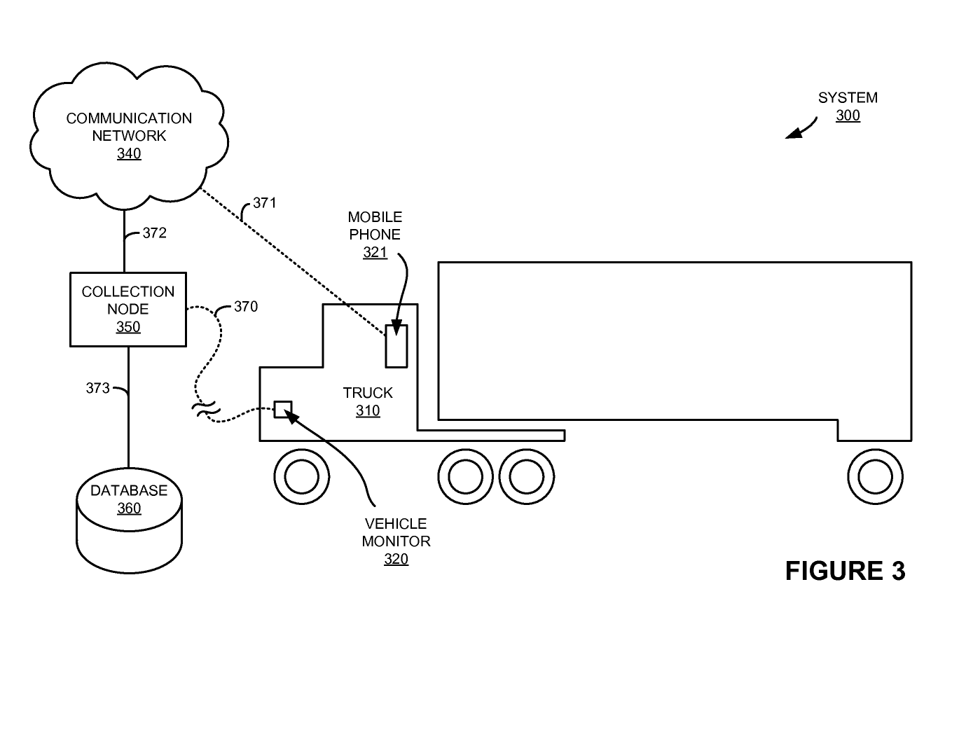

FIG. 3 is a system diagram illustrating vehicle monitoring system 300. System 300 includes truck 310, vehicle monitor 320, mobile phone 321, communication network 340, collection node 350, and database 360. Mobile phone 321 and communication network 340 communicate over wireless link 371. Communication network 340 and collection node 350 communicate over link 372. Collection node 350 and database 360 communicate over link 373. Collection node 350 and vehicle monitor 320 communicate over link 370, although link 370 may not be connected during operation of truck 310 in all examples.

Truck 310 is shown as a semi-trailer and tractor in this example. However, in other examples, truck 310 could instead be a different transportation vehicle, such as a passenger car, passenger truck, flatbed truck, construction vehicle, railway car, or other vehicle. Truck 310 includes vehicle monitor 320 and mobile phone 321.

Vehicle monitor 320 is coupled to the engine of truck 310. In this example, vehicle monitor 320 is coupled electrically to truck 310 through a vehicle interface (not shown) to monitor engine performance and receive information from the various systems associated with truck 310. The vehicle interface could include an OBD vehicle interface. Vehicle monitor 320 could also comprise a global positioning system (GPS) receiver, to receive and interpret signals from positioning satellites to determine geographic coordinates. Vehicle monitor 320 could also include a sensor portion, comprising thermometers, thermocouples, thermopiles, emitters/detectors, microphones, accelerometers, strain gauges, flow gauges, chemical sensors, micro-electromechanical system (MEMS) sensors, compasses, electrical sensors, among other sensing equipment and circuitry. Vehicle monitor 320 could also include a transceiver portion for communication with collection node 350 over link 370. In some examples, the transceiver portion includes a wireline transceiver for communicating over a wire, optical fiber, or other medium. In other examples, the transceiver portion includes a wireless transceiver and antenna. Vehicle monitor 320 could also include a processing portion for receiving sensor and vehicle information, amplifying, scaling, modifying, adjusting, digitizing, or converting the information, as well as for controlling the transceiver portion and sensor portions. Vehicle monitor 320 could also comprise a power system, such as a battery or solar cell.

In operation, vehicle monitor 320 senses and monitors equipment associated with truck 310. The information monitored could include geographic position, engine component temperature, ambient temperature, vibration, noise, acceleration, fuel usage, oxygen usage, emissions, braking, direction, steering, incline, engine start/stop status, transmission status, tire pressure, among other information. Vehicle monitor 320 is also configured to collect, store, and transfer the monitored information about truck 310. In some examples, vehicle monitor 320 is configured to wirelessly transmit the collected information to collection node 350, such as over a wireless communication network or satellite communication network while truck 310 is in motion. In other examples, vehicle monitor 320 is coupled via a wireless or wireline interface to collection node 350 while truck 310 is not in motion to transfer information collected and stored over a period of time, such as after a roundtrip delivery. Vehicle monitor 320 could also collect, store, and report other information, such as position, time, battery life, sensor status, inoperative sensors, serial numbers, equipment identifiers, among other information.

Mobile phone 321 is a mobile wireless telephone in this example. Mobile phone 321 comprises radio frequency (RF) communication circuitry and antenna elements. The RF communication circuitry typically includes amplifiers, filters, modulators, and signal processing circuitry. In many examples, mobile phone 321 includes circuitry and equipment to exchange communications of wireless communication services over wireless links, as provided by base stations associated with communication network 340. Mobile phone 321 may also include user interface systems, memory devices, computer-readable storage mediums, software, processing circuitry, cameras, sensor systems, accelerometers, compasses, GPS receivers, or other communication and circuitry components. Mobile phone 321 may also be another wireless communication device, such as subscriber equipment, customer equipment, access terminal, computer, e-book, mobile Internet appliance, wireless network interface card, media player, game console, or some other wireless communication apparatus, including combinations thereof. Although one mobile phone is shown in FIG. 3, it should be understood that a different number of mobile phones could be shown.

Mobile phone 321 could include complementary or additional sensors, equipment, and circuitry as to vehicle monitor 320 or collection node 350. In some examples, vehicle monitor 320 or collection node 350 are not employed, and only mobile phone 321 is employed. Specialized software or circuitry could be employed in mobile phone 321 to operate as described herein for vehicle monitor 323 or collection node 350.

Communication network 340 could include base stations, base station control systems, Internet access nodes, telephony service nodes, wireless data access points, routers, gateways, satellite systems, or other wireless communication systems, including combinations thereof. Communication network 340 may also comprise optical networks, asynchronous transfer mode (ATM) networks, packet networks, metropolitan-area networks (MAN), or other network topologies, equipment, or systems, including combinations thereof. In typical examples, communication network 340 includes many base stations and associated equipment for providing communication services to many wireless and mobile devices across a geographic region. In the example shown in FIG. 3, communication network 340 provides wireless communication service to mobile phone 340, such as cellular service, over a geographic area. Systems in communication network 340 also track and store usage information for mobile phone 321, such as call records, usage history, text message records, data usage, among other usage information.

Collection node 350 comprises equipment for receiving vehicle information about truck 310. In some examples, the vehicle information is received from communication network 340 over link 372, while in other examples, the information is received over other communication pathways. Collection node 350 also includes equipment for receiving estimated transit times from database 360 over link 373. Collection node 350 could comprise communication interfaces, as well as a computer system, microprocessor, circuitry, or some other processing device or software system, and may be distributed among multiple processing devices. Examples of collection node 350 may also include software such as an operating system, logs, utilities, drivers, networking software, and other software stored on a computer-readable medium. Collection node 350 could also include application servers, application service provider systems, database systems, logistics systems, web servers, or other systems. Collection node 350 could collect vehicle and mobile phone information from many vehicles and mobile phones.

Communication link 370 uses various communication media, such as air, space, metal, optical fiber, or some other signal propagation path, including combinations thereof. Communication link 370 could use various communication protocols, such as Internet Protocol (IP), Ethernet, Wireless Fidelity (WiFi), Bluetooth, Controller Area Network (CAN) bus, Inter-Integrated Circuit (I2C), 3-Wire, Radio Frequency Identification (RFID), optical, circuit-switched, communication signaling, or some other communication format, including combinations, improvements, or variations thereof. Communication link 370 could be a direct link or may include intermediate networks, systems, or devices. In some examples, communication link 370 operates wirelessly using wireless protocols as described for wireless link 371.

Wireless link 371 uses the air or space as the transport media. Wireless link 371 may use various protocols, such as Code Division Multiple Access (CDMA), Evolution-Data Optimized (EV-DO), single-carrier radio transmission technology link (3xRTT), Worldwide Interoperability for Microwave Access (WIMAX), Global System for Mobile Communication (GSM), Universal Mobile Telecommunications System (UMTS), Long Term Evolution (LTE), Wireless Fidelity (WiFi), High Speed Packet Access (HSPA), Radio Link Protocol (RLP), satellite phone communications, or some other wireless communication format, including combinations, improvements, or variations thereof.

Communication links 372-373 each use various communication media, such as air, space, metal, optical fiber, or some other signal propagation path, including combinations thereof. Communication links 372-373 could each use various communication protocols, such as Internet Protocol (IP), Ethernet, Wireless Fidelity (WiFi), Time Division Multiplex (TDM), asynchronous transfer mode (ATM), optical, synchronous optical networking (SONET), circuit-switched, communication signaling, or some other communication format, including combinations, improvements, or variations thereof. Communication links 372-373 each could be a direct link or may include intermediate networks, systems, or devices. In some examples, communication links 372-373 each operate wirelessly using wireless protocols as described for wireless link 371.

Links 370-373 may each include many different signals sharing the same link—as represented by the associated lines in FIG. 3—comprising access channels, forward links, reverse links, user communications, communication sessions, overhead communications, frequencies, other channels, carriers, timeslots, spreading codes, transportation ports, logical transportation links, network sockets, packets, or communication directions.

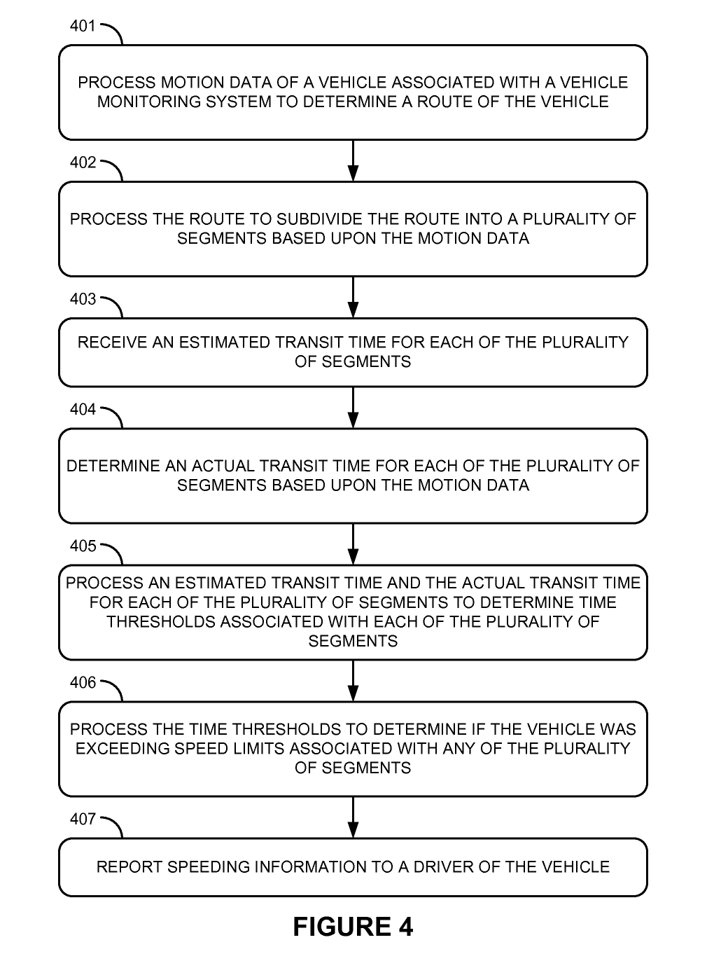

FIG. 4 is a flow diagram illustrating a method of operating vehicle monitoring system 300. The operations of FIG. 4 are referenced herein parenthetically. In FIG. 4, collection node 350 processes (401) motion data of a vehicle associated with vehicle monitor 320 to determine a route of the vehicle. In this example, the vehicle is truck 310. Collection node 350 receives information about the activities of truck 310. The information about the activities of truck 310 could be determined by vehicle monitor 320 or by mobile phone 321. In some examples, collection node 350 receives the information from vehicle monitor 320 over link 370. In other examples, collection node 350 receives the information from mobile phone 321 over wireless link 371. The vehicle information could include vehicle motion data or position information for truck 310, such as time, distance, velocity, acceleration, direction, geographic coordinates correlated to time, among other vehicle position information. The vehicle information could also include vehicle performance information, such as engine component temperature, ambient temperature, vibration, noise, fuel usage, oxygen usage, emissions, braking, steering position, incline, engine start/stop status, transmission status, tire pressure, time, battery life, sensor status, inoperative sensors, serial numbers, or other vehicle performance information.

Collection node 350 can process the activity information received about truck 310 to determine a route or trip of truck 310. For example, the activity information received about truck 310 could be processed to correlate motion data to predetermined routes, such as determining positions which correlate to known roads based upon mapping or route database information. In other examples, the activity information could define the route by assembling the motion data into a route. This activity information could also be correlated to timing information, such as timestamps which correlate to periodic intervals or driving events such as acceleration changes, directional chances, braking events, idle events, or other driving events. In further examples, a route could be defined based upon engine start and stop activity of truck 310.

Once a route has been determined for truck 310, collection node 350 processes (402) the route to subdivide the route into a plurality of segments based upon the motion data. A segment could be created based upon different motion data. For example, the route can be subdivided into segments based upon directional changes of truck 310 along the route. In other examples, the route can be subdivided into segments based upon idle events of truck 310, where idle events could be due to delivery stops or traffic signals. In yet further examples, the route could be subdivided into segments based upon truck 310 driving along differently numbered roads or highways, such as when exiting an interstate highway and entering a different road. In some examples, such as where a GPS receiver associated with vehicle 330 is used to provide position information which defines a route, GPS jitter could occur. GPS jitter occurs when geographic coordinates provided by a GPS receiver contains sufficient error to associate vehicle 330 with an incorrect or inaccurate road or route during a trip. GPS jitter could also create false segments or discontinuous segments, where truck 310 appears to be traveling temporarily or instantaneously along an adjacent or parallel road during a route. Collection node 350 could process the motion data information, along with other information, such as vehicle performance information, to determine when GPS jitter occurs and filter the jitter out to define a smooth route or eliminate false segments from a route. Collection node 350 could also process motion data points along a route where GPS jitter is suspected and analyze previous and subsequent motion data points to determine if jitter did occur.

Collection node 350 receives (403) an estimated transit time for each of the plurality of segments. An estimated transit time indicates how long vehicle 330 should take to drive each segment of the route. The estimated transit time for each segment could be retrieved from database 360 over link 373, over the Internet, or from other sources, which indicates estimated travel times along different portions of a route. For example, Internet mapping website information could be received which indicates estimated travel times for each segment. Collection node 350 also determines (404) an actual transit time for each of the plurality of segments based upon the motion data. The actual transit time is typically determined by processing the vehicle motion data or vehicle performance data to determine a time associated with each segment.

Collection node 350 processes (405) the estimated transit time and the actual transit time for each of the plurality of segments to determine time thresholds associated with each of the plurality of segments. The time thresholds can be used to determine if truck 310 was exceeding a speed limit over any of the segments, if the estimated transit times are incorrect, among other determinations. For example, an upper time threshold could be determined for a segment, which if exceeded could indicate that truck 310 drove very slowly, or could indicate that the estimated transit time for the segment is incorrect or inaccurate. As another example, a lower time threshold could be determined for a segment, which if fallen below, could indicate that truck 310 drove very quickly, possibly exceeding a speed limit for the segment. Other time thresholds or conclusions could be reached from the estimated transit time and actual transit time for each segment. In examples where collection node 350 determines that the estimated transit time for a segment is incorrect or inaccurate, a transit time exception database could be created. This transit time exception database could supplement the information received about the estimated transit times. For example, collection node 350 could receive estimated transit times after determining segments for a route of truck 310, and also query the exception database to determine if supplemental estimated transit time information is available for the segments.

Collection node 350 processes (406) the time thresholds to determine if the vehicle was exceeding speed limits associated with any of the plurality of segments and reports (407) speeding information to a driver of vehicle 330. As discussed above, the estimated and actual transit times could be processed to determine time thresholds. In examples where the actual transit time is far less than the estimated transit time for a segment, then collection node 350 could determine that speeding has occurred over the segment. Speed limits could be determined from these estimated transit times by processing the estimated transit times, time thresholds, distance, segment parameters, among other information. These speed limits can then be associated with each segment derived from the route. If the speed limit for a segment was exceeded during the route, then speeding information could be transferred to a driver of vehicle 330. The speeding information could be provided over a web-based interface, provided to mobile phone 321, or distributed in a paper report to a driver of truck 310, among other distribution methods. In other examples, the speeding information could be transferred to an operator or operating entity of truck 310, such as a transportation company, hub, or other entity. In yet further examples, the speeding information could be provided to a law enforcement agency. Also, in some examples, if the estimated transit time of a segment or route is greatly different than the actual transit time, it could be determined that truck 310 was traveling on an unmapped road, such as a utility service road, and speeding information could be modified for truck 310 regarding any speeding along that segment.

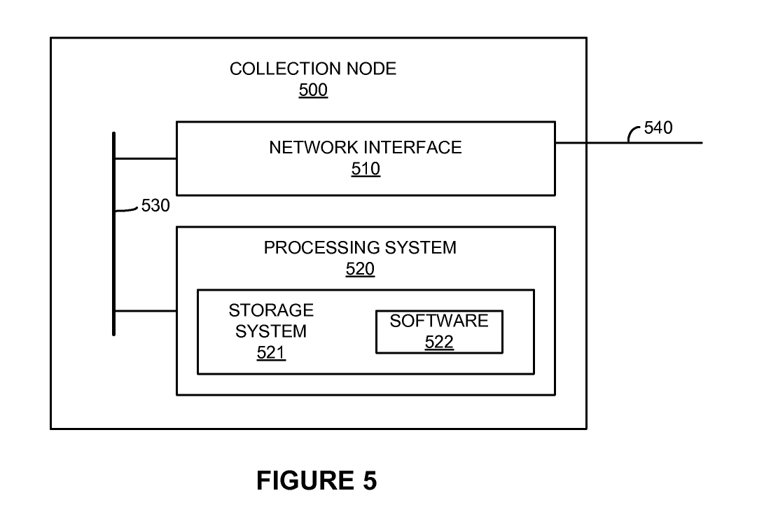

FIG. 5 is a block diagram illustrating collection node 500, as an example of collection node 150 found in FIG. 1 or collection node 350 found in FIG. 3, although collection node 150 or collection node 350 could use other configurations. Collection node 500 includes network interface 510 and processing system 520. Network interface 510 and processing system 520 communicate over bus 530. Collection node 500 may be distributed among multiple devices that together form elements 510, 520-522, 530, and 540.

Network interface 510 comprises network router and gateway equipment for communicating with a core network of a communication provider, such as with communication network 140 or communication network 340. Network interface 510 exchanges communications over link 540. Link 540 could use various protocols or communication formats as described herein for links 161-162 or 370-373, including combinations, variations, or improvements thereof.

Processing system 520 includes storage system 521. Processing system 520 retrieves and executes software 522 from storage system 521. In some examples, processing system 520 is located within the same equipment in which network interface 510 is located. In further examples, processing system 520 comprises specialized circuitry, and software 522 or storage system 521 could be included in the specialized circuitry to operate processing system 520 as described herein. Storage system 521 could include a non-transient computer-readable medium such as a disk, tape, integrated circuit, server, or some other memory device, and also may be distributed among multiple memory devices. Software 522 may include an operating system, logs, utilities, drivers, networking software, and other software typically loaded onto a computer system. Software 522 could contain an application program, firmware, or some other form of computer-readable processing instructions. When executed by processing system 520, software 522 directs processing system 520 to operate as described herein, such as receive vehicle activity information and mobile phone usage information, process the information to determine driver behavior during driving events, or identify a driver.

Bus 530 comprises a physical, logical, or virtual communication and power link, capable of communicating data, control signals, power, and other communications. In some examples, bus 530 is encapsulated within the elements of network interface 510 or processing system 520, and may include a software or logical link. In other examples, bus 530 uses various communication media, such as air, space, metal, optical fiber, or some other signal propagation path, including combinations thereof. Bus 530 could be a direct link or might include various equipment, intermediate components, systems, and networks.

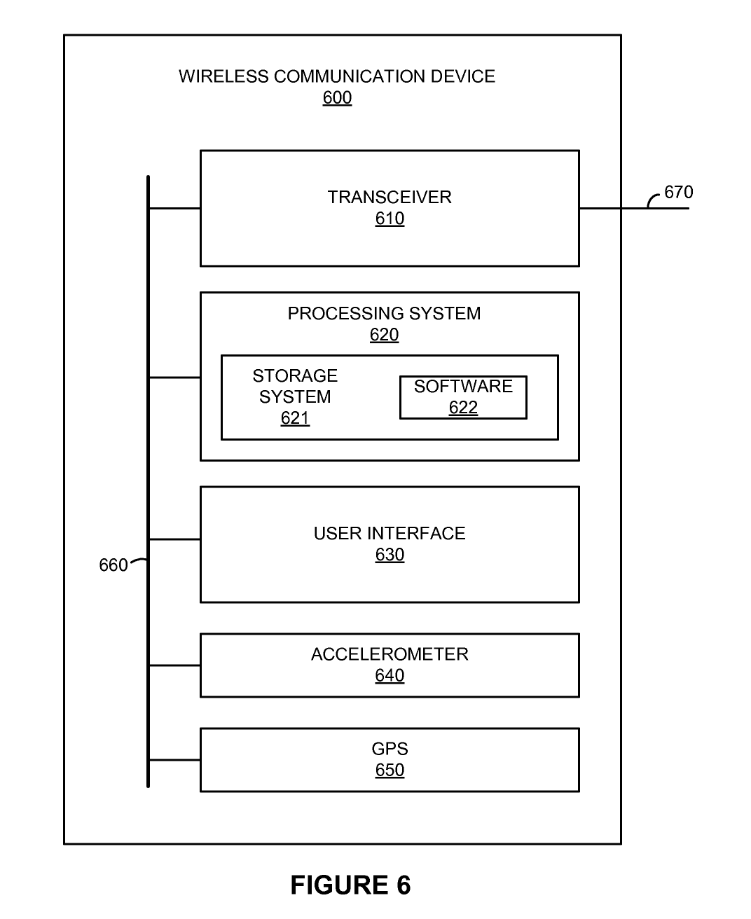

FIG. 6 is a block diagram illustrating wireless communication device 600, as an example of mobile phone 121 found in FIG. 1 or mobile phone 321 found in FIG. 3, although mobile phone 121 or mobile phone 321 could use other configurations. Wireless communication device 600 includes transceiver 610, processing system 620, user interface 630, accelerometer 640, and global positioning system (GPS) receiver 650. Transceiver 610, processing system 620, user interface 630, accelerometer 640, and GPS 650 communicate over bus 660. Wireless communication device 600 may be distributed or consolidated among devices that together form elements 610, 620-622, 630, 640, 650, 660, and 670.

Transceiver 610 comprises radio frequency (RF) communication circuitry and antenna elements. Transceiver 610 could also include amplifiers, filters, modulators, and signal processing circuitry. In this example, transceiver 610 can exchange instructions and information with processing system 620. Transceiver 610 also communicates with wireless access nodes and systems, such as base stations, omitted for clarity, over wireless link 670, to access communication services and exchange communications of the communication services. Wireless link 670 could use various protocols or communication formats as described herein for wireless link 161 or 370-371, including combinations, variations, or improvements thereof.

Processing system 620 includes storage system 621. Processing system 620 retrieves and executes software 622 from storage system 621. Processing system 620 could incorporate a computer microprocessor, logic circuit, or some other processing device, and may be distributed among multiple processing devices. Processing system 620 could be located within the same equipment or circuitry in which transceiver 610, user interface 630, accelerometer 640, or GPS 650 are located. Storage system 621 could include computer-readable media such as disks, tapes, integrated circuits, servers, or some other memory device, and also may be distributed among multiple memory devices. Software 622 may include an operating system, logs, utilities, drivers, networking software, and other software typically loaded onto a computer system. Software 622 could contain an application program, firmware, or some other form of computer-readable processing instructions. When executed by processing system 620, software 622 directs wireless communication device 600 to operate as described herein to access a communication services through a wireless access system in coordination with transceiver 610, as well as determine or receive vehicle activity information and mobile phone usage information, process the information to determine driver behavior during driving events, or identify a driver.

User interface 630 includes equipment and circuitry for receiving user input and control. Examples of the equipment and circuitry for receiving user input and control include push buttons, touch screens, selection knobs, dials, switches, actuators, keys, keyboards, pointer devices, microphones, transducers, potentiometers, non-contact sensing circuitry, or other human-interface equipment. User interface 630 also includes equipment to communicate information to a user of wireless communication device 600. Examples of the equipment to communicate information to the user could include indicator lights, lamps, light-emitting diodes, displays, haptic feedback devices, audible signal transducers, speakers, buzzers, alarms, vibration devices, or other indicator equipment, including combinations thereof.

Accelerometer 640 includes circuitry to detect and monitor acceleration of wireless communication device 600. This circuitry could include sensors, micro-electromechanical sensors (MEMS), optics, gyroscopes, inertial masses, amplifiers, conditioners, analog-to-digital converters, digital-to-analog converters, logic, or microprocessors, among other circuitry. Accelerometer 640 provides acceleration information over bus 650 to processing system 620 or transceiver 610.

Global positioning system (GPS) receiver 650 includes circuitry and antennas to receive and interpret signals from positioning satellites to determine geographic coordinates of wireless communication device 600. This circuitry could include sensors, amplifiers, conditioners, analog-to-digital converters, digital-to-analog converters, logic, or microprocessors, among other circuitry. GPS 650 provides positioning or location information over bus 650 to processing system 620 or transceiver 610.

Bus 660 comprises a physical, logical, or virtual communication link, capable of communicating data, control signals, communications, and power, along with other information and signals. In some examples, bus 660 is encapsulated within the elements of transceiver 610, processing system 620, user interface 630, accelerometer 640, or GPS 650, and may be a software or logical link. In other examples, bus 660 uses various communication media, such as air, space, metal, optical fiber, or some other signal propagation path, including combinations thereof. Bus 660 could be a direct link or might include various equipment, intermediate components, systems, and networks.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a vehicle monitoring system, comprising:
receiving activity information for a transportation vehicle;
receiving mobile phone usage information associated with the transportation vehicle;
processing the activity information and the mobile phone usage information to determine behavior of a driver operating the transportation vehicle.

2. The method of claim 1, further comprising:
processing the activity information and the mobile phone usage information to identify the driver operating the transportation vehicle.

3. The method of claim 1, wherein the behavior of the driver is determined during driving incidents of the transportation vehicle.

4. The method of claim 1, wherein the activity information and the mobile phone usage information are processed to determine when the driver was engaged in a phone activity on the mobile phone during the occurrence of a driving event.

5. The method of claim 4, wherein the driving event comprises a deceleration of the transportation vehicle.

6. A vehicle monitoring system, comprising:
a communication interface configured to receive activity information for a transportation vehicle as determined by a vehicle monitor;
the communication interface configured to receive mobile phone usage information associated with the transportation vehicle transferred by a communication network;
a processing system configured to process the activity information and the mobile phone usage information to determine behavior of a driver operating the transportation vehicle.

7. The vehicle monitoring system of claim 6, comprising:
the processing system configured to process the activity information and the mobile phone usage information to identify the driver operating the transportation vehicle.

8. The vehicle monitoring system of claim 6, comprising:
the processing system configured to determine the behavior of the driver driving incidents of the transportation vehicle.

9. The vehicle monitoring system of claim 6, comprising:
the processing system configured to determine when the driver was engaged in a phone activity on the mobile phone during the occurrence of a driving event.

10. The vehicle monitoring system of claim 9, wherein the driving event comprises a deceleration of the transportation vehicle.

11. A method of operating a vehicle monitoring system, comprising:
processing motion data of a vehicle associated with the vehicle monitoring system to determine a route of the vehicle;
processing the route to subdivide the route into a plurality of segments based upon the motion data;
receiving an estimated transit time for each of the plurality of segments;
determining an actual transit time for each of the plurality of segments based upon the motion data;
processing the estimated transit time and the actual transit time for each of the plurality of segments to determine time thresholds associated with each of the plurality of segments; and
processing the time thresholds to determine if the vehicle was exceeding speed limits associated with any of the plurality of segments and reporting speeding information to a driver of the vehicle.

12. The method of claim 11, wherein the motion data of the vehicle is determined by a mobile phone associated with a driver of the vehicle.

13. The method of claim 11, wherein the processing motion data to determine the route of the vehicle comprises processing the motion data to correlate the motion data to predetermined routes.

14. The method of claim 11, further comprising:
processing the motion data to determine when global positioning system (GPS) jitter occurs and filtering the GPS jitter out to eliminate false segments from the route of the vehicle.

15. The method of claim 11, further comprising:
if the estimated transit time of a first segment of the plurality of segments is different than the actual transit time for the first segment, determining if the vehicle was travelling on an unmapped route during the first segment, and modifying the speeding information based on the unmapped route.

16. A vehicle monitoring system, comprising:
a processing system configured to process motion data of a vehicle associated with the vehicle monitoring system to determine a route of the vehicle;
the processing system configured to process the route to subdivide the route into a plurality of segments based upon the motion data;
a communication interface configured to receive an estimated transit time for each of the plurality of segments;
the processing system configured to determine an actual transit time for each of the plurality of segments based upon the motion data;
the processing system configured to process the estimated transit time and the actual transit time for each of the plurality of segments to determine time thresholds associated with each of the plurality of segments;
the processing system configured to process the time thresholds to determine if the vehicle was exceeding speed limits associated with any of the plurality of segments; and
the communication interface configured to reporting speeding information to a driver of the vehicle.

17. The vehicle monitoring system of claim 16, wherein the motion data of the vehicle is determined by a mobile phone associated with a driver of the vehicle.

18. The vehicle monitoring system of claim 16, wherein the processing system is configured to process the motion data to correlate the motion data to predetermined routes to determine the route of the vehicle.

19. The vehicle monitoring system of claim 16, comprising:
the processing system configured to process the motion data to determine when global positioning system (GPS) jitter occurs and filtering the GPS jitter out to eliminate false segments from the route of the vehicle.

20. The vehicle monitoring system of claim 16, comprising:
if the estimated transit time of a first segment of the plurality of segments is different than the actual transit time for the first segment, the processing system configured to determine if the vehicle was travelling on an unmapped route during the first segment, and modify the speeding information based on the unmapped route.
